(19) United States
(12) Patent Application Publication
(10) Pub. No.: US 2025/0233258 A1
(43) Pub. Date: Jul. 17, 2025

(54) SEPARATOR AND BATTERY ASSEMBLY

(71) Applicant: Prime Planet Energy & Solutions, Inc., Tokyo (JP)

(72) Inventors: Tetsuji OMURA, Kobe-shi, Hyogo (JP); Shigeki MATSUTA, Kobe-shi, Hyogo (JP); Ryosuke IWATA, Kobe-shi, Hyogo (JP); Nao KOGAMI, Himeji-shi, Hyogo (JP)

(21) Appl. No.: 19/015,634

(22) Filed: Jan. 10, 2025

(30) Foreign Application Priority Data
Jan. 17, 2024 (JP) 2024-005288

(51) Int. Cl. H01M 50/291; H01M 50/209

(52) U.S. Cl. CPC H01M 50/291; H01M 50/209

(57) ABSTRACT

A separator includes a base portion and a protuberance portion protruding from the base portion in a first direction, wherein the protuberance portion includes a first portion and a second portion formed in one piece, the first portion has a shape symmetrical with respect to a first axis extending in the first direction, the second portion has a shape asymmetrical with respect to the first axis, and a volume of the first portion is larger than a volume of the second portion in the protuberance portion.

### CROSS REFERENCE TO RELATED APPLICATIONS

This nonprovisional application is based on Japanese Patent Application No. 2024-005288 filed on Jan. 17, 2024 with the Japan Patent Office, the entire contents of which are hereby incorporated by reference.

### BACKGROUND OF THE INVENTION

### Field of the Invention

The present technology relates to a separator and a battery assembly.

### Description of the Background Art

A battery assembly in which a plurality of batteries are stacked and the stack is restrained has been conventionally known. Each of Japanese Patent Laying-Open No. 2016-192520 and Japanese National Patent Publication No. 2023-518373 can be exemplified as disclosing such a conventional battery assembly.

### SUMMARY OF THE INVENTION

When a battery is expanded in the battery assembly restrained in the stacking direction, a compressive force is applied to a separator provided between the plurality of batteries, with the result that a restraining force applied to the battery is increased due to its reaction force. The reaction force applied to the battery is required to be suppressed from being excessively increased when an amount of compression of the separator is increased. The conventional structure is not necessarily sufficient from the above-described viewpoint.

An object of the present technology is to provide: a separator by which a reaction force applied to a battery is suppressed from being excessively increased when an amount of compression is increased; and a battery assembly including the separator.

The present technology provides the following separator and the following battery assembly.
[1] A separator provided between a plurality of batteries arranged in a first direction or between a battery and an end plate, the separator comprising: a base portion; and a protuberance portion protruding from the base portion in the first direction, wherein the protuberance portion includes a first portion and a second portion formed in one piece, the first portion has a shape symmetrical with respect to a first axis extending in the first direction, the second portion has a shape asymmetrical with respect to the first axis, and a volume of the first portion is larger than a volume of the second portion in the protuberance portion.
[2] The separator according to [1], wherein the first portion and the second portion are adjacent to each other in the first direction.
[3] The separator according to [1], wherein the first portion and the second portion are adjacent to each other in a second direction orthogonal to the first direction.
[4] The separator according to any one of [1] to [3], wherein the second portion is formed entirely in a cross section of the protuberance portion in the first direction.
[5] The separator according to any one of [1] to [3], wherein the second portion is formed partially in a cross section of the protuberance portion in the first direction.
[6] A battery assembly comprising: a plurality of batteries arranged in a first direction; and the separator according to any one of [1] to [5], the separator being provided between the plurality of batteries.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view showing a battery assembly.

FIG. 2 is a perspective view of a battery included in the battery assembly.

FIG. 3 is a front view of a separator included in the battery assembly.

FIG. 4 is a front view of a modification of the separator.

FIG. 5 is a diagram showing an exemplary protuberance portion provided in the separator.

FIG. 6 is a cross sectional view of the protuberance portion shown in FIG. 5.

FIG. 7 is a cross sectional view showing a state in which the protuberance portion shown in FIG. 5 is compressed.

FIG. 8 is a diagram showing a relation between an amount of compression and a reaction force of the protuberance portion shown in FIG. 5.

FIG. 9 is a diagram showing another exemplary protuberance portion provided in the separator.

FIG. 10 is a cross sectional view of the protuberance portion shown in FIG. 9.

FIG. 11 is a cross sectional view showing a state in which the protuberance portion shown in FIG. 9 is compressed.

FIG. 12 is a diagram showing a relation between an amount of compression and a reaction force of the protuberance portion shown in FIG. 9.

FIG. 13 is a first cross sectional view showing a modification of the protuberance portion.

FIG. 14 is a second cross sectional view showing a modification of the protuberance portion.

FIG. 15 is a third cross sectional view showing a modification of the protuberance portion.

FIG. 16 is a fourth cross sectional view showing a modification of the protuberance portion.

FIG. 17 is a fifth cross sectional view showing a modification of the protuberance portion.

FIG. 18 is a sixth cross sectional view showing a modification of the protuberance portion.

FIG. 19 is a first front view showing another modification of the separator.

FIG. 20 is a second front view showing another modification of the separator.

FIG. 21 is a third front view showing another modification of the separator.

FIG. 22 is a fourth front view showing another modification of the separator.

FIGS. 23A to 23C are diagrams each showing a state in which protuberance portions are compressed while being in contact with each other.

FIGS. 24A and 24B are diagrams each schematically showing an apparatus for finding a relation between a compression ratio and a load of the separator.

FIG. 25 is a diagram showing a relation of compression ratio-load of the separator.

### DESCRIPTION OF THE PREFERRED EMBODIMENTS

Hereinafter, embodiments of the present technology will be described. It should be noted that the same or corresponding portions are denoted by the same reference characters, and may not be described repeatedly.

It should be noted that in the embodiments described below, when reference is made to number, amount, and the like, the scope of the present technology is not necessarily limited to the number, amount, and the like unless otherwise stated particularly. Further, in the embodiments described below, each component is not necessarily essential to the present technology unless otherwise stated particularly. Further, the present technology is not limited to one that necessarily exhibits all the functions and effects stated in the present embodiment.

It should be noted that in the present specification, the terms “comprise”, “include”, and “have” are open-end terms. That is, when a certain configuration is included, a configuration other than the foregoing configuration may or may not be included.

Also, in the present specification, when geometric terms and terms representing positional/directional relations are used, for example, when terms such as “parallel”, “orthogonal”, “obliquely at 45°”, “coaxial”, and “along” are used, these terms permit manufacturing errors or slight fluctuations. In the present specification, when terms representing relative positional relations such as “upper side” and “lower side” are used, each of these terms is used to indicate a relative positional relation in one state, and the relative positional relation may be reversed or turned at any angle in accordance with an installation direction of each mechanism (for example, the entire mechanism is reversed upside down).

In the present specification, the term “battery” is not limited to a lithium ion battery, and may include other batteries such as a nickel-metal hydride battery and a sodium ion battery. In the present specification, the term “electrode” may collectively represent a positive electrode and a negative electrode.

The “battery” in the present specification can be mounted on vehicles such as a hybrid electric vehicle (HEV), a plug-in hybrid electric vehicle (PHEV), and a battery electric vehicle (BEV). It should be noted that the use of the “battery” is not limited to the use in a vehicle.

FIG. 1 is a perspective view of a battery module according to the present embodiment. As shown in FIG. 1, battery assembly 1 includes batteries 100 and separators 200. Batteries 100 and separators 200 are arranged alternately along a Y axis direction (first direction).

The plurality of batteries 100 are battery cells each having a prismatic shape, and are provided along the Y axis direction. The plurality of batteries 100 are electrically connected together by a bus bar (not shown).

Separators 200 are provided between the plurality of batteries 100. Each of separators 200 is an insulating member that prevents unintended electrical conduction between adjacent batteries 100. Separator 200 secures an electrical insulation property between adjacent batteries 100. Separator 200 is also provided between a battery 100 and an end plate (not shown).

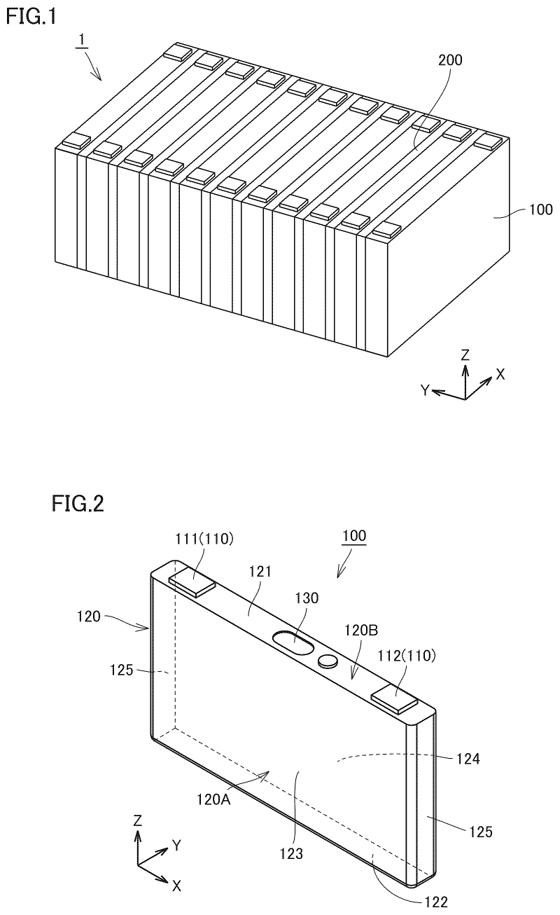

FIG. 2 is a perspective view showing each battery 100. As shown in FIG. 2, battery 100 has a prismatic shape. Battery 100 has electrode terminals 110, a housing 120, and a gas-discharge valve 130.

Electrode terminals 110 are formed on housing 120. Electrode terminals 110 have a positive electrode terminal 111 and a negative electrode terminal 112 arranged side by side along an X axis direction (second direction) orthogonal to the Y axis direction (first direction). Positive electrode terminal 111 and negative electrode terminal 112 are provided to be separated from each other in the X axis direction.

Housing 120 has a rectangular parallelepiped shape and forms an external appearance of battery 100. Housing 120 includes: a case main body 120A that accommodates an electrode assembly (not shown) and an electrolyte solution (not shown); and a sealing plate 120B that seals an opening of case main body 120A. Sealing plate 120B is joined to case main body 120A by welding.

Housing 120 has an upper surface 121, a lower surface 122, a first side surface 123, a second side surface 124, and two third side surfaces 125.

Upper surface 121 is a flat surface orthogonal to a Z axis direction (third direction) orthogonal to the Y axis direction and the X axis direction. Electrode terminals 110 are disposed on upper surface 121. Lower surface 122 faces upper surface 121 along the Z axis direction.

Each of first side surface 123 and second side surface 124 is constituted of a flat surface orthogonal to the Y axis direction. Each of first side surface 123 and second side surface 124 has the largest area among the areas of the plurality of side surfaces of housing 120. Each of first side surface 123 and second side surface 124 has a rectangular shape when viewed in the Y axis direction. Each of first side surface 123 and second side surface 124 has a rectangular shape in which the X axis direction corresponds to the long-side direction and the Z axis direction corresponds to the short-side direction when viewed in the Y axis direction.

The plurality of batteries 100 are stacked such that first side surfaces 123 of batteries 100, 100 adjacent to each other in the Y direction face each other and second side surfaces 124 of batteries 100, 100 adjacent to each other in the Y axis direction face each other. Thus, positive electrode terminals 111 and negative electrode terminals 112 are alternately arranged in the Y axis direction in which the plurality of batteries 100 are stacked.

Gas-discharge valve 130 is provided in upper surface 121. When the temperature of battery 100 is increased (thermal runaway) and internal pressure of housing 120 becomes more than or equal to a predetermined value due to gas generated inside housing 120, gas-discharge valve 130 discharges the gas to outside of housing 120.

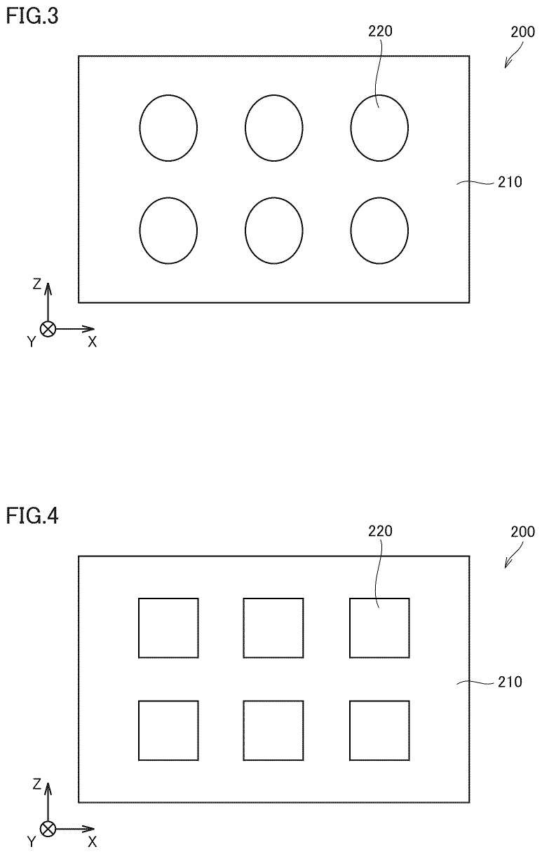

Each of FIGS. 3 and 4 is a front view of separator 200. Separator 200 shown in FIG. 4 is a modification of separator 200 shown in FIG. 3. As shown in FIGS. 3 and 4, separator 200 includes a base portion 210 and protuberance portions 220 each protruding from base portion 210 in the Y axis direction.

Separator 200 can be composed of a material having electrical insulation property and elasticity. Separator 200 can be composed of, for example, a silicone rubber, a fluoro-rubber, a urethane rubber, a natural rubber, a styrene-butadiene rubber, a butyl rubber, an ethylene propylene rubber (EPM, EPDM), a butadiene rubber, an isoprene rubber, a norbornene rubber, or the like. Separator 200 is preferably composed of the silicone rubber or the fluoro-rubber.

The hardness (Shore A hardness) of the material of separator 200 is preferably about 30 or more and 90 or less, is more preferably about 40 or more and 80 or less, and is further preferably about 50 or more and 70 or less.

Separator 200 according to the present embodiment has one feature in the shapes or arrangement of protuberance portions 220. Hereinafter, an implementation of each protuberance portion 220 will be described.

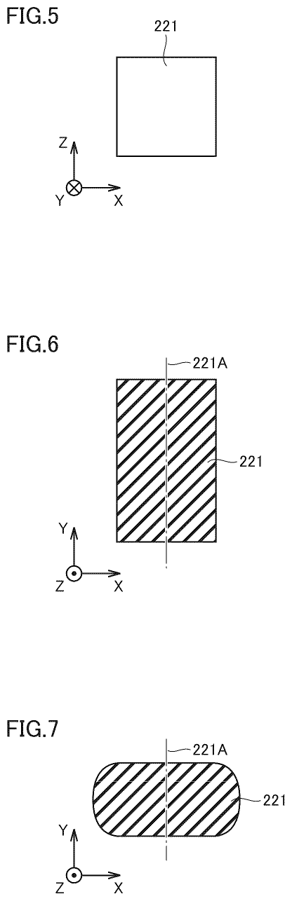

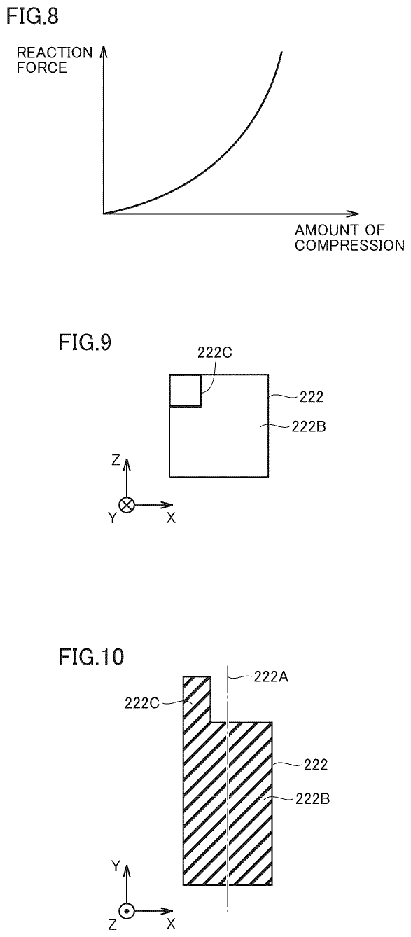

FIG. 5 is a diagram showing a protuberance portion 221 serving as an exemplary protuberance portion provided in separator 200, FIG. 6 is a cross sectional view of protuberance portion 221, and FIG. 7 is a cross sectional view showing a state in which protuberance portion 221 is compressed. Further, FIG. 8 is a diagram showing a relation between an amount of compression and a reaction force of protuberance portion 221.

As shown in FIG. 5, protuberance portion 221 has a substantially quadrangular shape when viewed in the Y axis direction, but the shape of the protuberance portion is not limited thereto. As shown in FIGS. 6 and 7, protuberance portion 221 has a cross sectional shape symmetrical with respect to a central axis 221A (first axis) extending in the Y axis direction.

When a compression force in the Y axis direction is applied to protuberance portion 221 from the state shown in FIG. 6, protuberance portion 221 is compressed while central axis 221A maintains its straight-line shape as shown in FIG. 7. On this occasion, as the amount of compression of protuberance portion 221 is increased, the reaction force thereof is also increased as shown in FIG. 8.

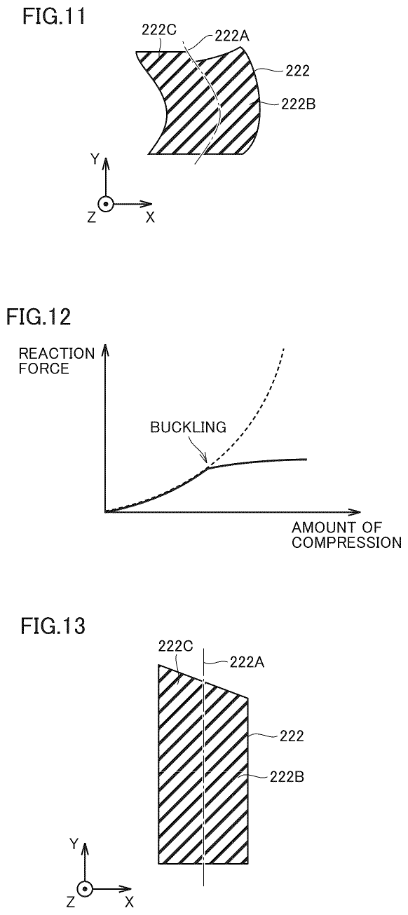

FIG. 9 is a diagram showing a protuberance portion 222 serving as another exemplary protuberance portion provided in separator 200, FIG. 10 is a cross sectional view of protuberance portion 222, FIG. 11 is a cross sectional view showing a state in which protuberance portion 222 is compressed, and FIG. 12 is a diagram showing a relation between an amount of compression and a reaction force of protuberance portion 222.

As shown in FIG. 9, protuberance portion 222 has a substantially quadrangular shape when viewed in the Y axis direction. As shown in FIGS. 10 and 11, protuberance portion 222 includes: a main body portion 222B (first portion) having a cross sectional shape symmetrical with respect to a central axis 222A (first axis) extending in the Y axis direction; and an asymmetrical portion 222C (second portion) further protruding from a portion of its tip in the Y axis direction and having a shape asymmetrical with respect to central axis 222A.

Main body portion 222B and asymmetrical portion 222C are formed in one piece. The volume of main body portion 222B is larger than the volume of asymmetrical portion 222C in protuberance portion 222.

When a compression force in the Y axis direction is applied to protuberance portion 222 from the state shown in FIG. 10 and the compression force exceeds a predetermined magnitude, central axis 222A of protuberance portion 222 is deformed to be curved as shown in FIG. 11. That is, when the compressive force exceeding the predetermined magnitude is applied to protuberance portion 222, protuberance portion 222 having a columnar shape is buckled. As shown in FIG. 12, in a region in which the buckling load is exceeded, the amount of compression is increased with a small load.

When protuberance portions 221, 222 are both present as protuberance portions 220 of separator 200 according to the present embodiment, the reaction force applied to battery 100 can be suppressed from being excessively increased when the amount of compression of separator 200 is increased, while ensuring a minimum necessary compression reaction force.

The arrangements and shapes of protuberance portions 221, 222 in separator 200 can be appropriately changed.

Each of FIGS. 13 to 18 is a cross sectional view showing a modification of protuberance portion 222. As shown in FIG. 13, asymmetrical portion 222C may have a tapered shape protruding in the Y axis direction from main body portion 222B. On this occasion, main body portion 222B and asymmetrical portion 222C are adjacent to each other in the Y axis direction.

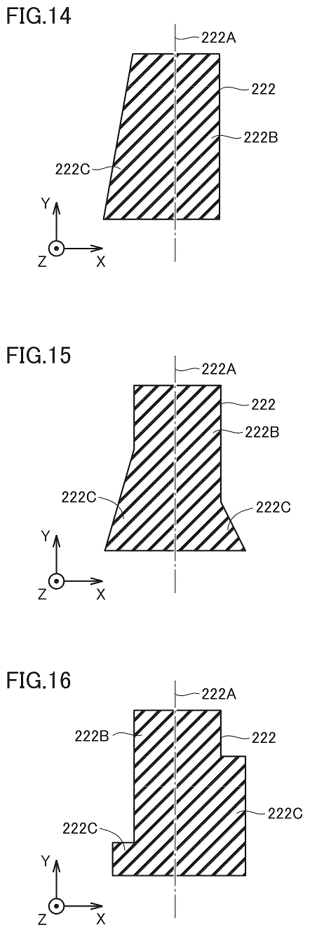

As shown in FIGS. 14 and 15, asymmetrical portion 222C may have a tapered shape protruding from main body portion 222B in the X axis direction. On this occasion, main body portion 222B and asymmetrical portion 222C are adjacent to each other in the X axis direction.

Asymmetrical portion 222C may be formed on only one side with respect to main body portion 222B in the X axis direction (FIG. 14) or may be formed on each of both sides with respect to main body portion 222B in the X axis direction (FIG. 15). Asymmetrical portion 222C may be formed entirely in the Y axis direction (FIG. 14) or may be formed partially in the Y axis direction (FIG. 15).

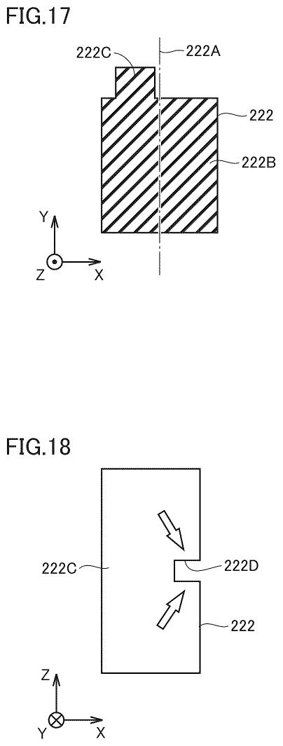

Even when the cross sectional shape that forms asymmetrical portion 222C is a quadrangular shape, the cross sectional shape is not limited to the example of FIG. 10, and may be a shape illustrated in each of FIGS. 16 and 17. Further, as shown in FIG. 18, asymmetrical portion 222C may be formed in the following manner: a portion of protuberance portion 222 having a columnar shape is provided with a recess 222D opened in the X axis direction when viewed in the Y axis direction. Recess 222D may be opened in the Z axis direction. On this occasion, deformation in directions of closing the opening of recess 222D is promoted as indicated by arrows in FIG. 18.

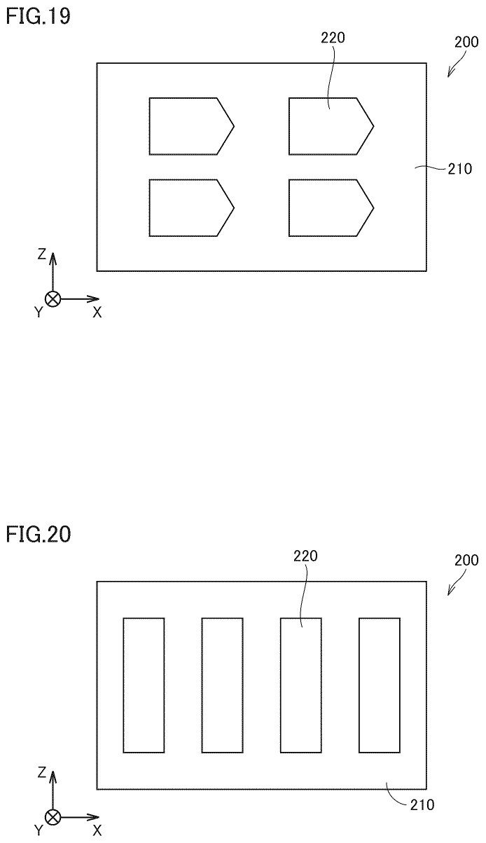

Each of FIGS. 19 to 22 is a front view showing another modification of separator 200, and shows a modification of the arrangement of protuberance portions 220 in separator 200.

As in the example of FIG. 19, the shape of each protuberance portion 220 may be a combination of a quadrangular shape and a tapered shape. As in the example of FIG. 20, protuberance portion 220 may have an elongated shape when viewed in the Y axis direction. In the example of FIG. 20, the Z axis direction corresponds to the long-side direction and the X axis direction corresponds to the short-side direction; however, the Z axis direction may correspond to the short-side direction and the X axis direction may correspond to the long-side direction, or the long-side direction may be an oblique direction (a direction intersecting both the X axis direction and the Z axis direction).

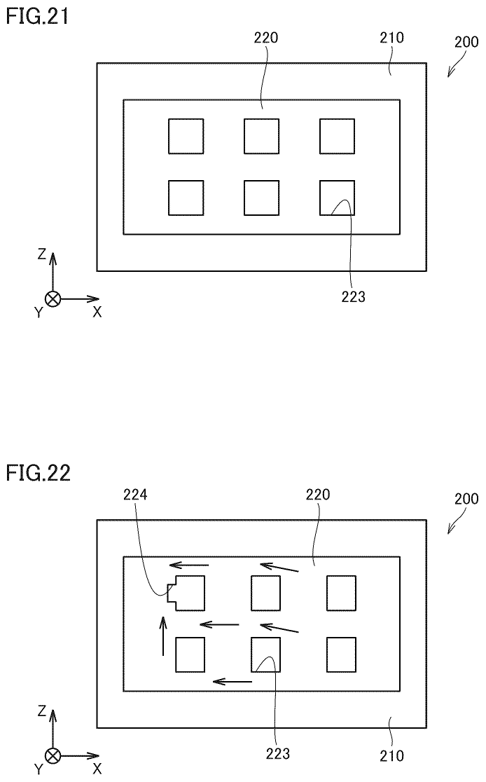

As in the example of FIG. 21, protuberance portion 220 may have such a shape that a hole portion 223 is provided inside a quadrangular shape. One or a plurality of hole portions 223 may be provided. The number and arrangement of hole portions 223 can be changed appropriately. Further, as in the example of FIG. 22, a recess 224 may be provided at a part of the outer edge of hole portion 223.

In the example of FIG. 22, a portion around hole portion 223 in which recess 224 is formed is likely to be deformed and this portion is therefore likely to be buckled. That is, in the example of FIG. 22, the portion around recess 224 constitutes the “asymmetrical portion” of protuberance portion 220.

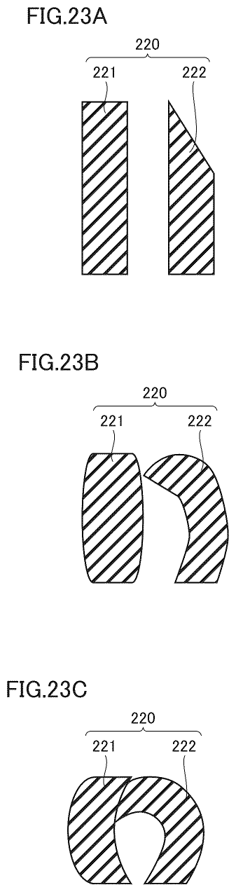

FIGS. 23A to 23C are diagrams each showing a state in which protuberance portions 221, 222 are compressed while being in contact with each other. As shown in FIG. 23A, protuberance portion 221 having no asymmetrical portion and protuberance portion 222 having an asymmetrical portion are provided adjacent to each other at a distance equal to or less than the protuberance height. When a compressive force is applied to protuberance portions 220 from the state shown in FIG. 23A, protuberance portion 221 is compressed while standing substantially vertically whereas protuberance portion 222 is buckled and is compressed to be inclined toward protuberance portion 221 as shown in FIG. 23B. When the compression force applied to protuberance portion 220 is further increased from the state shown in FIG. 23B, protuberance portion 222 buckled and inclined is brought into contact with protuberance portion 221 to proceed the compression while protuberance portion 222 presses protuberance portion 221 as shown in FIG. 23C. In this way, the reaction force applied to battery 100 can be suppressed from being excessively increased when the amount of compression of separator 200 is increased.

On this occasion, separator 200 facing the peripheral edge portion of battery 100 can be provided with protuberance portion 221 that is not brought into contact with protuberance portion 222 even when protuberance portion 222 is buckled. Since protuberance portion 221 in separator 200 facing the peripheral edge portion of battery 100 is not buckled even when protuberance portion 222 is buckled, a distance to adjacent battery 100 can be maintained.

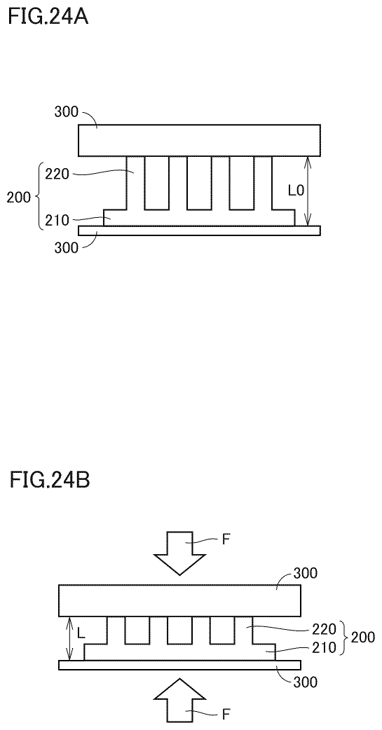

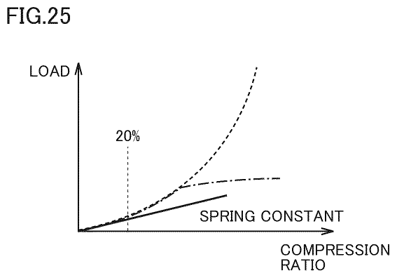

FIGS. 24A and 24B are diagrams each schematically showing an apparatus for finding a relation between a compression ratio and a load of separator 200. FIG. 25 is a diagram showing a relation of compression ratio-load of separator 200.

As shown in FIGS. 24A and 24B, separator 200 is compressed using a jig 300 so as to find a relation between a load F (reaction force) and the compression ratio at that time. The compression ratio is found by the following formula:

Compression ratio=(L0−L)/L0

As shown in FIG. 25, the slope of a compression ratio-load curve until the compression ratio becomes 0.2 (20 percent) is defined as a “spring constant” of separator 200. The “spring constant” of separator 200 according to the present embodiment is preferably about 1 MPa or more and 10 MPa or less.

Although the embodiments of the present invention have been described and shown in detail, it is clearly understood that the same is by way of illustration and example only and is not to be taken by way of limitation. The scope of the present invention is defined by the terms of the claims, and is intended to include any modifications within the scope and meaning equivalent to the terms of the claims.

What is claimed is:

1. A separator provided between a plurality of batteries arranged in a first direction or between a battery and an end plate, the separator comprising:
a base portion; and
a protuberance portion protruding from the base portion in the first direction, wherein
the protuberance portion includes a first portion and a second portion formed in one piece,
the first portion has a shape symmetrical with respect to a first axis extending in the first direction,
the second portion has a shape asymmetrical with respect to the first axis, and
a volume of the first portion is larger than a volume of the second portion in the protuberance portion.

2. The separator according to claim 1, wherein the first portion and the second portion are adjacent to each other in the first direction.

3. The separator according to claim 1, wherein the first portion and the second portion are adjacent to each other in a second direction orthogonal to the first direction.

4. The separator according to claim 1, wherein the second portion is formed entirely in a cross section of the protuberance portion in the first direction.

5. The separator according to claim 1, wherein
the first portion and the second portion are adjacent to each other in the first direction, and
the second portion is formed entirely in a cross section of the protuberance portion in the first direction.

6. The separator according to claim 1, wherein
the first portion and the second portion are adjacent to each other in a second direction orthogonal to the first direction, and
the second portion is formed entirely in a cross section of the protuberance portion in the first direction.

7. The separator according to claim 1, wherein the second portion is formed partially in a cross section of the protuberance portion in the first direction.

8. The separator according to claim 1, wherein
the first portion and the second portion are adjacent to each other in the first direction, and
the second portion is formed partially in a cross section of the protuberance portion in the first direction.

9. The separator according to claim 1, wherein
the first portion and the second portion are adjacent to each other in a second direction orthogonal to the first direction, and
the second portion is formed partially in a cross section of the protuberance portion in the first direction.

10. A battery assembly comprising:
a plurality of batteries arranged in a first direction; and
the separator according to claim 1, the separator being provided between the plurality of batteries.
